(19) United States
(12) Patent Application Publication
(10) Pub. No.: US 2014/0121789 A1
(43) Pub. Date: May 1, 2014

(54) ADVISABLE STATE OF CONTROLLED OBJECTS IN FACTORY AUTOMATION SYSTEMS

(71) Applicant: ROCKWELL AUTOMATION TECHNOLOGIES, INC., Mayfield Heights, OH (US)

(72) Inventors: Russell Brandes, Brunswick, OH (US); Michael W. Rudder, Kirtland, OH (US); Dale E. Reed, Cleveland Heights, OH (US)

(73) Assignee: Rockwell Automation Technologies, Inc., Mayfield Heights, OH (US)

(21) Appl. No.: 13/663,889

(22) Filed: Oct. 30, 2012

(51) Int. Cl. G05B 11/01; G05B 15/02

(52) U.S. Cl. 700/80; 700/83

(57) ABSTRACT

An advisable state notification framework for an operator interface system is provided. Advisable states represent events detected within an industrial system that are less critical than alarm events but that nevertheless warrant notification. The framework supports multiple classes of advisable states, which are configured and handled separately from alarm states. Each class of advisable state is notified using a unique graphical icon. Moreover, the framework distributes advisable state icons on selected screens throughout the display screen navigational hierarchy to guide the operator to screens that identify the source of the advisable state. The notification and guidance features are inherent to the operator interface development environment, accelerating development time and reducing the need to create a custom notification framework.

### TECHNICAL FIELD

The subject application relates generally to industrial automation, and, more particularly, to systems and methods for configuration and presentation of advisable state notifications for industrial automation systems.

### BACKGROUND

Industrial controllers and their associated I/O devices are central to the operation of modem automation systems. These controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such programming structures. The controller receives any combination of digital, analog, or networked data signals from the field devices indicating current states of the process (e.g., temperature, position, part presence or absence, fluid level, etc.), and executes the control program to automate decision-making for the process based on the received signals. The controller then outputs appropriate digital, analog, or networked control signaling to the field devices in accordance with the decisions made by the control program. These outputs can include device actuation signals, temperature or position control signals, motion control commands, commands to machining or material handling robots, and the like.

To facilitate operator interaction with the industrial controller (and with the processes controlled thereby), industrial control systems often include at least one operator interface (e.g., a human-machine interface or other such visualization system) that communicates with the industrial controller and visualizes data therein on one or more user-developed or pre-configured display screens. The HMI screens also allow an operator to issue commands (e.g., machine start commands) or write values (e.g., setpoint values, recipe values, etc.) to the controller to control or alter the industrial process being automated.

Some operator interface systems support configuration of alarm conditions that cause the interface to present a visual and/or audible alarm indication to the operator in response to specified system or device states. For example, an exemplary operator interface may include an alarm database that allows the developer, during the development stage, to define which device parameters, machine states, process events, etc. are to trigger an alarm notification on the operator interface during runtime. In some systems, this is accomplished in the operator interface development environment by selecting, from a tag database of all tags configured for the operator interface, a tag representing the device parameter, machine state, process event, etc. for which an alarm is desired, and setting a configuration option for the tag that configures the tag to be an alarm tag. The development environment may also allow the developer to indicate the particular tag state (e.g., ON, OFF, value greater than X, value less than X, etc.) that is to trigger the alarm. During runtime, when the selected tag transitions to the indicated alarm state, the operator interface conveys the alarm status to the operator according to pre-configured alarm preferences and/or native alarm presentation features of the operator interface (e.g., an alarm banner at the bottom of the display screen, a dedicated alarm screen, etc.). Using this or similar configuration methods, operator interface systems afford the user a degree of control over presentation of status information for controlled objects in the industrial automation system, particularly with regard to alarmed versus non-alarmed object states.

However, in addition to critical alarm states, the broad range of state information generated by many industrial automation systems often includes conditions that are not sufficiently critical to warrant an alarm status, but for which personnel may require notification or reminding. Although such system conditions can be configured as alarms using the operator interface's native alarming features described above, treating critical alarms and non-critical notification events in the same way can cause an excessive number of alarm notifications to be presented to the operator, some of which are not true alarm conditions. As a result, the operator may overlook truly critical alarms because of a surplus of alarm notifications. Moreover, since some operator interfaces dedicate a finite number of alarming resources and bandwidth (e.g., placing a limit on the number of tags that can be configured as alarm tags), configuring both alarm states and non-alarm states as alarm events can quickly exhaust the limited resources designated for alarming.

In addition, many operator interface systems lack the ability to easily configure a navigational structure that allows the operator to quickly navigate from a notification display object to the relevant display screen containing more detailed information about the notification (e.g., the screen relating to the process, machine, device, and/or parameter that is the subject of the notification).

The above-described deficiencies of today's industrial control and business systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

One or more embodiments of the present disclosure relate to configuration and presentation of advisable state notifications for industrial automation systems. To this end, an operator interface system can include native configuration features that allow for configuration of advisable state notifications that are differentiated from alarm notifications. In one or more embodiments, these configuration features can include a classification mechanism that allows for classification of advisable object characteristics according to several types of advisable states (e.g., maintenance states, device configuration errors, etc.). By providing development tools that facilitate configuration of advisable states in an operator interface, one or more embodiments of this disclosure can allow a system designer to incorporate another advisory mechanism—separate from and in addition to alarming—to notify users of notable conditions (e.g., advisable states) within an industrial automation system or devices therein. This mitigates the necessity to configure such advisable states as alarms, thereby freeing the operator interface's native alarming resources to be used exclusively for notification of critical operator actionable events.

In addition, one or more embodiments described herein provide a navigational mechanism by which an operator can navigate in a guided fashion through interface screens or object hierarchies to locate additional information regarding an advisable state notification. Operator interface systems according to such embodiments can include a standardized navigation framework that allows an operator to quickly browse to relevant information relating to a selected advisable state notification. Such navigation frameworks can be inherent to the development environment, simplifying development of advisable state navigation and substantially mitigating the need for a developer to build customized screen or object navigations in an ad-hoc fashion using more generalized vendor-supplied development frameworks. In some embodiments, the advisable state notification and navigation features inherent to the operator interface system can leverage, in part, data provided by industrial controller tags or other data structures in the controller designed to operate in conjunction with the advisable state features. These data tags, which can represent, for example, controlled devices or process states, can include readable parameters that track maintenance statuses, configuration validation results, I/O faults, operational statuses, or other such advisable states.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a high-level overview of an exemplary, generalized control environment in which advisable state notification and navigation features can be used.

FIG. 2 is a block diagram illustrating data mapping between an operator interface and a controller.

FIG. 3 is a block diagram illustrating exemplary components of an operator interface and an industrial controller that facilitate advisable state notification and navigation.

FIG. 4 illustrates an exemplary organizational hierarchy that can be used as a basis for a historian data model

FIG. 5 depicts an exemplary navigation chart representing operator interface screen navigation for an operator interface application.

FIG. 6 illustrates guided navigation from an agitator overview graphic to a speed control home screen.

FIG. 7 illustrates guided navigation from a speed control home screen to a speed control tag configuration screen.

FIG. 8 illustrates guided navigation from a speed control tag configuration screen to a speed control scaling screen that identifies a root cause of an advisable state.

FIG. 9 illustrates guided navigation from a pump overview screen to a pump home screen.

FIG. 10 illustrates guided navigation from a pump home screen to a maintenance screen that identifies a source of a maintenance bypass state.

FIG. 11 is a flowchart of an example methodology for providing advisable state notifications to an operator on an operator interface.

FIG. 12 is a flowchart of an example methodology for class-specific guided navigation in response to an advisable state event.

FIG. 13 is an example computing environment.

FIG. 14 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

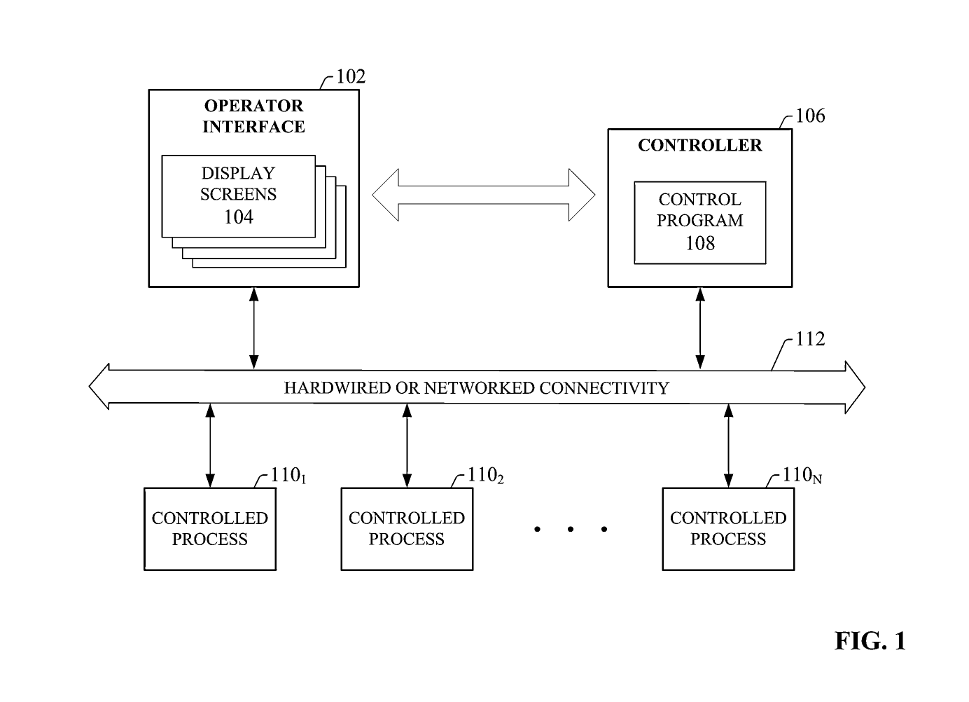

FIG. 1 illustrates an exemplary, generalized control environment in which the advisable state notification and navigation features of this disclosure can be used. An industrial facility can comprise one or more controlled processes 110₁-110_{N} relating to product manufacture, batch processing, material handling, or other such industrial functions. Controlled processes 110₁-110_{N} can be monitored and controlled by at least one controller 106. Controller 106 can comprise an industrial controller, such as a programmable logic controller (PLC) or other such programmable automation controller (PAC), that executes a control program 108 to facilitate monitoring and control of controlled processes 110₁-110_{N}. Controller 106 may also comprise a soft controller executed on a personal computer or other hardware platform. Control program 108 can comprise any conceivable type of code used to process input signals read into the controller 106 and to control output signals from the controller, including but not limited to ladder logic, sequential function charts, function block diagrams, or structured text. Data read into or generated by controller 106 can be stored in memory addresses within controller memory, which can comprise native memory or removable storage media.

Controller 106 can communicatively interface with controlled processes 110₁-110_{N} over hardwired or networked connections 112. For example, controller 106 can be equipped with native hardwired inputs and outputs that communicate with one or more field devices associated with the controlled processes 110₁-110_{N} to effect control of the devices. The native controller I/O can include digital I/O that transmits and receives discrete voltage signals to and from the field devices, or analog I/O that transmits and receives analog voltage or current signals to and from the devices. The controller I/O can communicate with the controller's processor over a backplane such that the digital and analog signals can be read into and controlled by the control programs. Controller 106 can also communicate with field devices over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. It is to be appreciated that controller 106 is not limited to the above specifications, and can include virtually any type of controller used to control an industrial process.

The system can also include at least one operator interface 102 (e.g., a human-machine interface, or HMI) communicatively coupled with controller 106 (e.g., via network 112). Operator interface 102 can exchange data with controller 106 to facilitate visualization of information relating to controlled processes 110₁-110_{N} and to allow an operator to submit data to controller 106 in the form of issued commands (e.g., cycle start commands, device actuation commands, etc.), setpoint values, and the like. Operator interface 102 can include one or more display screens 104 through which the operator interacts with the controller 106, and thereby with the controlled processes 110₁-110_{N}. Exemplary display screens can visualize present states of the controlled processes 110₁-110_{N} using graphical representations of the processes that display metered or calculated values, employ color or position animations based on state, render alarm notifications, or employ other such techniques for presenting relevant data to the operator. Data presented in this manner is read from controller 106 by operator interface 102 and presented on one or more of the display screens 104 according to display formats chosen by the system developer.

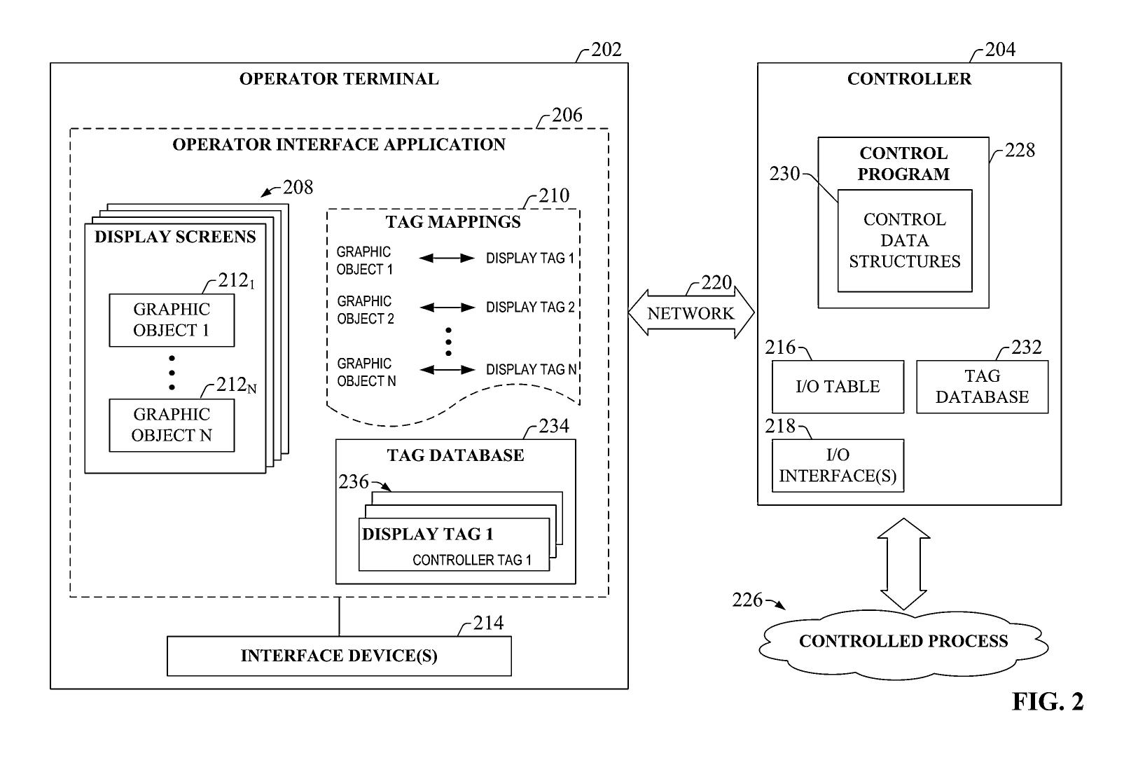

To facilitate visualization of controller data on the operator interface, the visualization application running on the operator interface can be configured to map selected controller addresses or tags to selected graphical elements of the display screens. FIG. 2 illustrates some functional elements of the operator interface and the controller in more detail. In this exemplar system, controlled process 226 can represent any industrial process or operation under the control of controller 204 (similar to controlled processes 110 of FIG. 1). Controlled process 226 can comprise a number of devices that receive command signals from or send telemetry data to controller 204 over any suitable combination of hardwired or networked connectivity to regulate a controlled process or operation. Controller 204 can also include one or more I/O interfaces 218 that provide hardwired or networked connectivity to the controlled equipment and telemetry devices comprising the controlled process 226. These I/O interfaces can include, for example, digital and/or analog input modules, digital and/or analog output modules, networking modules, or the like. An I/O table 216 within the controller's memory can maintain present analog and digital values of the various inputs and outputs read from or written to the I/O interfaces 218. That is, data values read from field devices by I/O interfaces 218 (e.g., analog or digital input modules) can be written to the I/O table 216. These input values can then be read by control program 228 which updates its control variables accordingly. Similarly, output values generated by the control program 228 can be written to I/O table 216, causing corresponding output data signals to be applied to the analog or digital output modules comprising the I/O interfaces 218.

Control program 228 can include a number of control data structures 230 that perform data handling and instruction processing functions within the program. Exemplary data structures can include control instructions (e.g., function blocks, instruction blocks, etc.) and controller tags of various data types. During program development, the control instructions can be selected from a set of control instructions available within the programming platform. These control instructions can include generalized instructions (e.g. timer blocks, counters, etc.) and industry-specific control instructions (e.g., PID instructions for process control applications, pulse multiplier instructions for motor drive control applications, axis control instructions for motion control applications, etc.). Controller tags are data structures that reference a data item or memory location within the controller (e.g., an input value, an output value, or an internal data register). A controller tag can be configured to be of a specified data type, such as binary, floating point, integer, double integer, string, etc. During development, controller tags can be created and maintained in a tag database 232. According to one or more embodiments of the present disclosure, some control data structures can also represent particular devices being monitored and/or controlled by controller 204. For example, a given control data structure may represent a motor or associated motor drive, and can comprise multiple parameters or tags representing the drive's current operational statuses, parameter values, configuration settings, or other state information for the motor or drive. These device statuses can be read from the control data structure by control program 228 and used to facilitate automated decision making in connection with control of the controlled process 226. Control program 228 and its associated control data structures 230 serve to regulate controlled process 226 via the I/O interfaces 218.

Operator interface application 206 running on operator terminal 202 facilitates operator interaction with controller 204 via network 220, visualizing control data associated with the controlled process 226 and allowing an operator to submit control inputs into the system. Operator interface application 206 can comprise one or more display screens 208, each display screen containing static and/or dynamic content that conveys current states of the controlled process 226. Display screen content can include, for example, graphic objects 212₁-212_{N}, where N is an integer. Graphic objects 212₁-212_{N} can comprise dynamic display objects configured to change visual state in accord with control data read from the controller 204. Such graphic objects can include numerical display objects that render a value of a control register read from the controller, bar or line graphs that display a trend of one or more data registers over time, animated graphical icons representing field devices or equipment that alter their appearance to convey a current state of the devices, or other such elements. One or more graphic objects 212₁-212_{N} can also encode functionality that allows an operator to enter a value to be written to a control register within the controller 204 (e.g., a setpoint value) or to set/reset a bit within the controller (e.g. issue a start or stop command to a device via the control program). Operators can interact with the display screens 208 and their respective graphic objects via the operator terminal's interface devices 214, which can include one or more of a mouse, a keyboard, a touch screen, voice recognition receiver, or other suitable interface devices

In some operator interface systems, data objects are represented by display tags 236 maintained in a tag database 234. In the present example, each of the display tags 236 is configured to map to a particular controller tag (e.g., in the controller's tag database 232), thereby creating an instance of the value of the controller tag in the operator interface environment that can be used in connection with building display screens 208. Linkages between a graphic object 212 and a particular controller tag can be configured using tag mappings 210 that define associations between graphic objects 212 and display tags 236. These tag mappings can be configured within the graphic objects themselves during development of the operator interface application. For example, a valve control graphic object can include an OPEN pushbutton portion linked to a start bit in control program 228, and a state color animation linked to a corresponding “valve open” state register in the control program 228.

As noted above, many operator interface applications allow alarms to be configured such that selected operator actionable events or statuses of the controlled process 226 (as determined by values of the control data structures, tags, or I/O values read from the controller) trigger an alarm notification on the operator interface. These alarm notifications convey to the operator that a critical event has occurred (e.g., an event that stops or prevents operation of a portion of the controlled process 226) which requires action by the operator before the controlled process 226 is allowed to continue. Alarm notifications can also convey text strings describing the nature of the actionable event. Accordingly, some operator interface development environments include an alarm configuration framework that allows alarm events and alarm notification preferences to be defined. For example, some systems allow selected display tags within the tag database 232 to be configured as alarm tags. For each alarm tag, the developer can define the condition of the tag that will trigger the alarm (for digital tags, this can include specifying whether the alarm event is triggered when the tag is in the ON state or in the OFF state; for analog tags, this can include specifying a setpoint value above or below which the alarm event will be triggered). During runtime, alarm events triggered by these preconfigured conditions will be displayed using native alarming display features of the operator interface application 206 (e.g., on an alarm banner located at a defined position of the screen, on a dedicated alarm screen, etc.).

Industrial control systems typically generate a broad range of device, machine, and/or process states of varied degrees of criticality. In addition to the critical operator actionable alarms described above, an industrial control system may also generate events that, while not necessarily requiring immediate operator action, are nevertheless sufficiently notable to warrant informing or reminding the operator. Due to the limitations of some operator interface development environments, some developers simply configure these types of notifications—referred to herein as “advisable states”—using the alarm configuration resources described above. This causes the operator interface system to handle such advisable states as merely another alarm.

However, there are a number of drawbacks to using an operator interface's alarm configuration framework for notification of both actual alarm states and advisable states. For example, if the operator interface is configured to display all alarms in list form on an alarm summary screen or banner, the operator must make a judgment regarding which of the listed events are true alarm conditions requiring operator action, and which are merely advisable state events. In a related problem, critical alarm events are more easily overlooked on such a display configuration since a given critical alarm may be listed among multiple less critical advisable states, which are more likely to be ignored by the operator. Moreover, some operator interface systems designate a limited amount of configuration resources to alarming (e.g., limiting the number of alarm tags that can be configured). Consequently, using the interface's native alarming resources for both true alarms and advisable states consumes alarming resources better used for configuration of critical alarm events.

To address these and other issues, one or more embodiments of the present application provide a framework for configured advisable states in an operator interface development environment that is separate from the alarming configuration framework. As will be described in more detail below, this advisable state configuration framework can include the capability to classify advisable states according to several vendor-configured or user-configured classes of advisable states. The development framework can also include a number of pre-built tools that facilitate intuitive screen navigation from a high-level advisable state notification to screens that provide additional information regarding the root cause of the advisable state. These advisable state navigation structures can be native to the development environment, reducing or eliminating the burden on the developer to create customized navigation structures using more limited development frameworks. In one or more embodiments, some features of the advisable state development framework may be realized through interaction with specialized device tags in the industrial controller, which can be configured to provide device, machine, or process state information that can be leveraged by the advisable state framework of the operator interface to facilitate documentation and navigation of advisable state notifications.

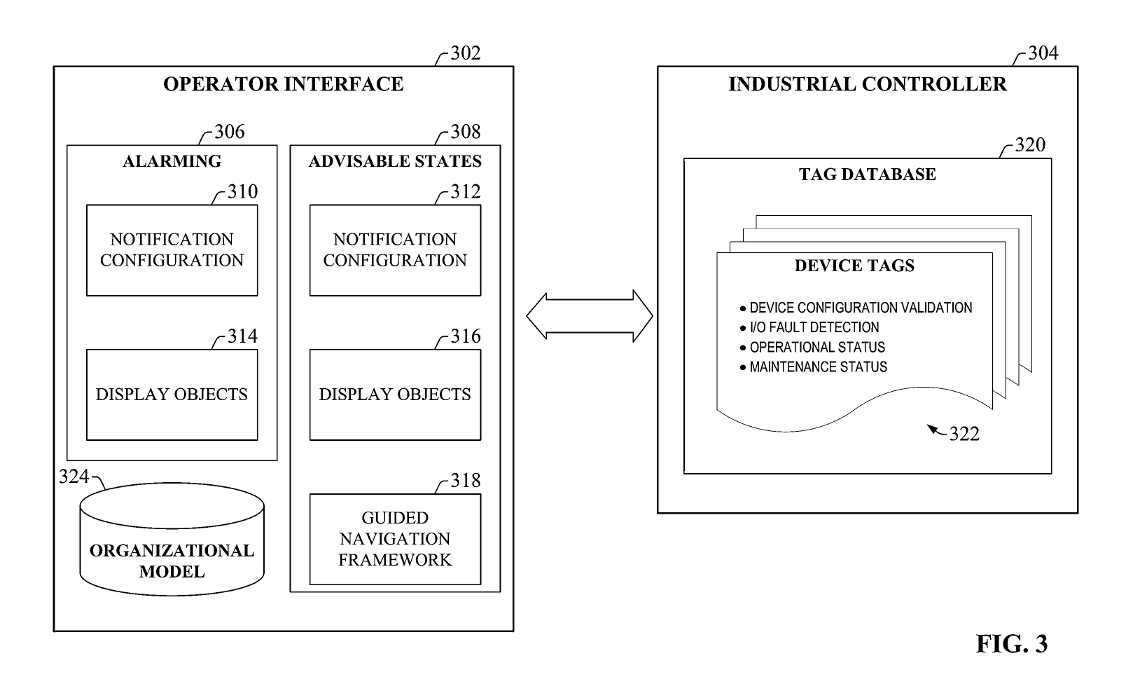

FIG. 3 illustrates exemplary components of an operator interface and an industrial controller that facilitate advisable state notification and navigation according to one or more embodiments of this disclosure. As described in previous examples, an operator interface 302 is configured to exchange data with an industrial controller 304. The operator interface 302 includes a set of alarming development resources 306 used to configure alarm notifications to be rendered by the operator interface 302 during runtime. These include tools for alarm notification configuration 310 which allow the developer to specify control system states and events that will trigger an alarm notification. Alarming development resources 306 can also include a set of display objects 314 used to render alarm notifications, such as alarm banner objects, alarm list objects, animated alarm indicator objects, or other such display objects.

According to one or more embodiments of this disclosure, operator interface 302 can also include a set of advisable state development resources 308, separate from the alarming state development resources 306, used to configure various classes of advisable state notifications. These advisable state development resources 308 can include, for example, tools for advisable state notification configuration 312, which allow the developer to specify the device, machine, or process states that will trigger an advisable state notification. As will be described in more detail below, advisable state development resources 308 can support multiple classes or types of advisable states (e.g., maintenance states, configuration validation states, etc.), and can allow the developer to select or specify an advisable state class for respective advisable state notifications.

Advisable state development resources 308 can also include a library of display objects 316 for rendering the advisable state notifications. According to one or more embodiments, these advisable state display objects 316 can support rendering of distinct notification icons that respectively correspond to the different classes of advisable states. Such class-based notification icons can quickly convey to the operator, from a high-level notification view, the class or type of advisable state that has occurred (e.g., maintenance bypass, configuration error, etc.), providing the operator with an initial notification that also conveys an event classification that may assist in determining whether the event should be investigated immediately, or alternatively if the event can be acted upon at a later time. Advisable state display objects 316 can also include a library of vendor-provided notification screens or overlay windows that can facilitate navigation to additional information regarding a root cause of the advisable state event, as will be discussed in more detail below.

Advisable state development resources 308 can also include a guided navigation framework 318 that allows the operator to navigate from a high-level advisable state notification to screens providing additional information about the root cause of the notification. This guided navigation framework 318 can be inherent to the overall operator interface development framework, reducing or eliminating the burden on operator interface developers to create customized navigation structures using the relatively limited configuration tools of some operator interface development environments. In a non-limiting example, a developer using the advisable state development resources 308 may create a display object (e.g., one of the display objects 316) that maps to a device tag (e.g., one of the device tags 322) in industrial controller 304, where the device tag represents a motor to be monitored and controlled in an industrial automation system. Once created in the operator interface development environment, the motor display object can inherit advisable state notification functionality provided by the advisable state framework. This can include recognition by the framework that certain states associated with the display object must trigger certain classes of advisable states.

For example, a motor speed scaling value for the motor represented by the display object may trigger a “configuration error” advisable state if the scaling value is outside a defined range or is incompatible with another configuration setting. Accordingly, if this scaling value is determined to be outside the acceptable range for a valid configuration during runtime of the operator interface 302, the advisable state notification framework will render an appropriate class-specific advisable state icon on or near the display object representing the motor (e.g., an icon representing a “configuration error” advisable state). While this advisable state is active, selecting the icon on the graphical object (e.g., using a cursor, via tactile interaction with a touch screen, etc.) will trigger navigation through one or more pre-developed display screens that guide the operator to the source of the configuration error. The navigation path or structure can depend on the type of advisable state and/or the source of the advisable state event. Moreover, the navigation path from the high-level icon to the root cause of the event can be determined automatically by the native advisable state framework without the need for a developer to define the navigation steps from the display object to the screen(s) identifying the source of the event during the development phase.

In some embodiments, the advisable state framework described herein can leverage a hierarchical organizational model 324 to facilitate extensibility of the advisable state notification and navigation features throughout an industrial enterprise hierarchy represented in operator interface 302. Organizational model 324 can represent an industrial enterprise in terms of multiple hierarchical levels, where each level comprises units of the enterprise organized as instances of types and their properties. Exemplary types can include, for example, assets (e.g., pumps, extruders, tanks, fillers, welding cells, utility meters, etc.), structures (e.g., production lines, production areas, plants, enterprises, production schedules, operators, etc.), and processes (e.g., quality audit, repairs, test/inspection, batch, product parameters, shifts, etc.).

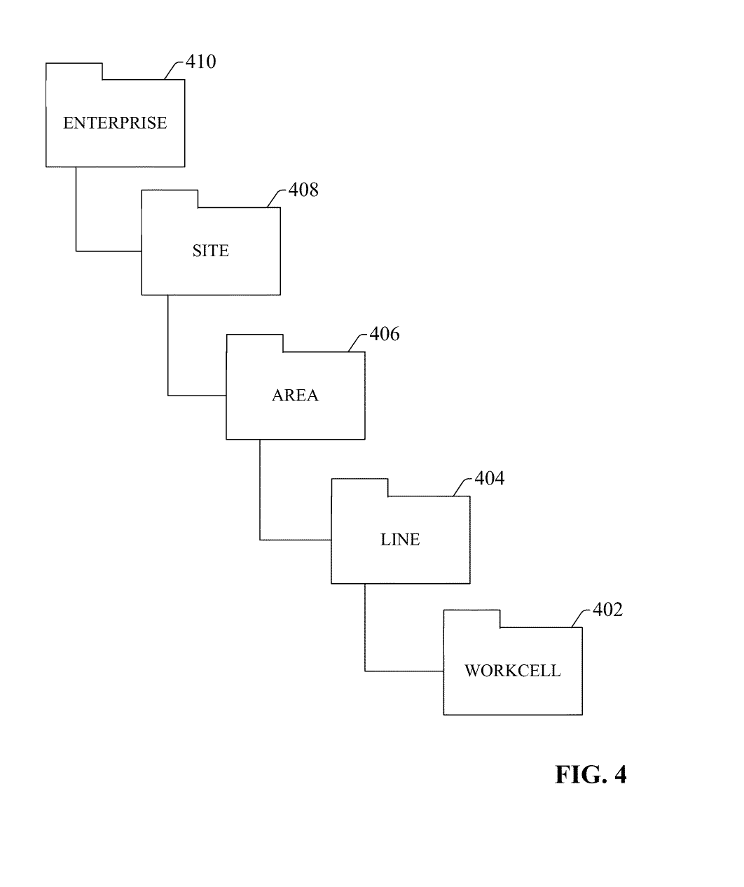

Turning briefly to FIG. 4, an exemplary organizational hierarchy that can be used as a basis for organizational model 324 is illustrated. In this exemplary organizational model, the hierarchical levels can include—from lowest to highest—a workcell level 402, a line level 404, an area level 406, a site level 408, and an enterprise level 410. The type instances described above—representing units of the enterprise—can be defined for respective levels of this hierarchical structure. In one or more embodiments, the advisable state framework described herein can provide a standard set of types that allow a developer to model an industrial enterprise in terms of these standard types. The framework may also allow custom types to be created, allowing users to represent their particular business or manufacturing processes using a combination of standard and user-defined types.

The advisable state framework can refer to organizational model 324 in connection with rendering a given advisable state notification on appropriate display screens and graphic objects throughout multiple hierarchical views. For example, a maintenance bypass notification for a particular machine may cause the advisable state framework to render a Maintenance Bypass icon on or near a graphic object representing the machine rendered on a workcell-level display screen. In addition, since the organizational model 324 defines a number of higher organizational levels above the workcell level—including a line, area, site, and enterprise level—the framework will propagate the advisable state indication upward through the chain of organizational relationships defined by organizational model 324, such that the Maintenance Bypass icon is rendered on or near suitable graphic objects on each level (e.g., hierarchical view) of the operator interface. For example, if the bypassed machine in the example above is part of a #2 Die-cast line, the advisable state framework will render a notification, not only on the graphic object for the bypassed machine, but also on an area overview screen for the Die-cast area in which the #2 Die-cast line resides, and a site overview screen (on which the maintenance bypass icon may be rendered on a graphic representing the particular site or facility that houses the Die-cast area). Thus, the advisable state framework can operate in conjunction with organizational model 324 to cause advisable state notifications to be inherited upward through a chain of defined organizational relationships, thereby creating a navigational structure that guides an operator to a source of an advisable state from any hierarchical view.

As noted above, some features of the advisable state framework can be realized through interaction with device tags 322 in the controller 304 that support advisable state notification. In some embodiments, device tags 322 representing devices in the controlled system (or particular parameters or measured values of such devices) may include data structures that support and enable advisable state notification on the operator interface 302. For example, some device tags may support device configuration validation, such that the device tag maps to and retrieves configuration parameter data from the device (e.g., from the appropriate configuration registers within the device), allowing this configuration parameter data to be verified as being within valid ranges. In some embodiments, the determination of whether the device parameter data is within a valid range can be made within industrial controller 304. Alternatively, the device tag in the controller can provide the configuration parameter data to a corresponding display tag in the operator interface 302, and the determination of whether the configuration parameter data is valid can be made within the operator interface framework.

In either case, the determination can be based on known valid ranges for the respective parameter values. For example, a particular device tag 322 in industrial controller 304 may correspond to a variable frequency drive (VFD) for a motor being monitored and controlled by industrial controller 304. In some embodiments, a device profile for the particular VFD and/or motor in use may be maintained in one or both of the industrial controller 304 or the operator interface application. This device profile can include maximum and minimum values for all configuration parameters (e.g., motor speed scaling values). Accordingly, during runtime of the operator interface 302, either the industrial controller 304 or the advisable state framework in the operator interface can determine whether each configuration parameter is valid by comparing the parameters with the device profile. If a configuration parameter for the VFD is found to be outside the valid range for that parameter, the advisable state framework within the operator interface can initiate a “configuration error” advisable state notification for the device, which includes rendering a “configuration error” icon on or near the display object(s) linked to the device tag corresponding to the VFD or its associated motor, and establishing a navigation path from the icon to one or more display screens that provide additional information regarding the notification.

Similar to device configuration validation, device tags 322 can support retrieval and/or provision of data relating to one or more of I/O fault detection, operational status, maintenance status, or other such advisable state classes. Such data can be mapped from the device tags to corresponding display tags in the operator interface 302 and leveraged by the advisable state framework to facilitate class-specific advisable state notification and navigation.

As noted above, the advisable state development framework can simplify or automate configuration of advisable state notification and navigation for an operator interface application. Moreover, the framework supports multiple classes of advisable states which determine how notification and/or navigation is handled for a particular advisable state event. For example, the advisable state framework may include support for an “Invalid Configuration” class of advisable states. This class of advisable states refers to detection of an invalid device configuration setting for a device of an industrial automation system (e.g., a VFD parameter setting, an industrial controller setting, an I/O scaling value of an I/O module). A device configuration setting or parameter may be considered invalid when, for example, the value for the setting is outside a vendor-defined or user-defined operational range for that setting. In another example, a device configuration setting or parameter may be considered invalid if the value for the parameter conflicts with a value of a different configuration for the device. These criteria for determining whether a configuration setting is invalid are only intended to be exemplary, and the “Invalid Configuration” class is intended to encompass substantially any type of state in which a configuration setting for a device is considered invalid.

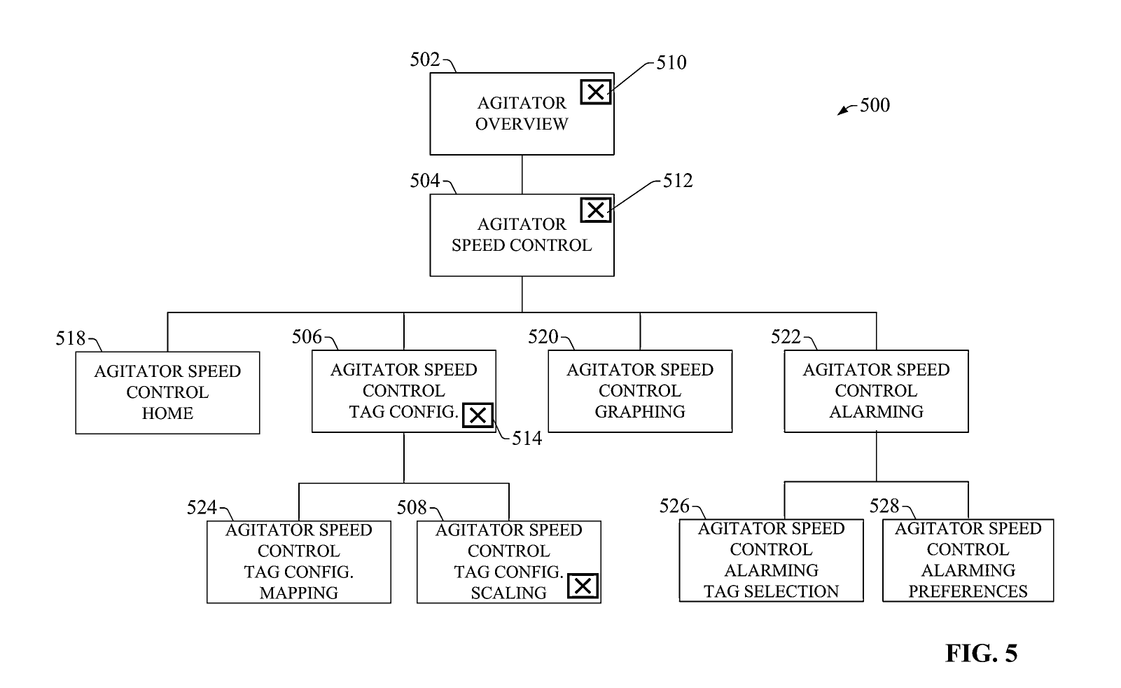

An exemplary notification and navigation scenario for an “Invalid Configuration” class of advisable state is now discussed. FIG. 5 depicts an exemplary navigation chart representing operator interface screen navigation for an operator interface application. The set of screens depicted in navigation map 500 represent a subset of operator interface screens relating to agitators of a mixing system monitored by the operator interface. The agitator screen set includes an agitator overview screen 502, which acts as a high-level summary screen for all agitators in the system. This screen may include graphical icons representing the respective agitators, together with a relatively small number of basic operational statistics (e.g., running state and current speed values) for each agitator. From the agitator overview screen 502, the operator can navigate to an agitator speed control screen 504 for a selected agitator displayed on the agitator overview screen 502. The agitator speed control screen 504 for a given agitator can be invoked by selecting a graphical object representing the given agitator on the agitator overview screen 502 (e.g., using a mouse-controlled cursor, by touching the graphical object on a touch-sensitive screen, etc.).

From the agitator speed control screen 504, the operator can navigate to one of four sub-screens relating to speed control (a speed control home screen 518, a tag configuration screen 506, a graphing screen 520, or an alarming screen 522). From the tag configuration screen 506, the operator can further navigate to a tag configuration mapping screen 524 or a tag configuration scaling screen 508. From the alarming screen 522, the operator can navigate to either an alarming tag selection screen 526 or an alarming preferences screen 528.

In the present example, a user-configurable scaling parameter for one of the tags associated with a particular agitator metric has been inadvertently set to an invalid value. This scaling parameter is used by the system to convert a raw data value for the metric received from the agitator to a scaled value that represents the value in more meaningful engineering units. In some systems, the scaling configuration values are written to a respective registers in the controller (e.g., to respective variables of a device tag representing the agitator in the controller), either directly via a controller programming interface or through data entry fields on a designated operator interface screen. In some embodiments, the determination that one or more scaling parameters are invalid can be made by the industrial controller. For example, the controller may determine that the device tag variables corresponding to the scaling parameters are outside acceptable ranges or are incompatible with one another. In such embodiments, the device tag can send a notification to a corresponding display object on the industrial controller that is mapped to the agitator's device tag. The notification can inform the operator interface that an “invalid configuration” advisable state event has been detected, and identify which configuration value has been found invalid. Alternatively, detection of the invalid configuration value may be made on the operator interface side by inspection of the scaling parameter values in the display tag that is mapped to the controller's device tag.

In either case, detection of the invalid configuration event causes the advisable state framework of the operator interface to trigger an “invalid configuration” advisable state notification for the agitator. In response to detection of the invalid configuration value, the advisable state framework displays a class-specific icon on appropriate screens throughout the screen hierarchy that both notifies the operator of the advisable state and facilitates guided navigation to the source of the advisable state event. In the present example, “Invalid Configuration” states are represented by an icon comprising a magenta “X” inside a similarly colored box (other classes of invalid configurations are represented by different icons). This icon will be distributed throughout the navigation map 500 on screens relating to the agitator, and will be displayed on or near appropriate graphical objects or navigational links that facilitate guided navigation to the source of the invalid configuration.

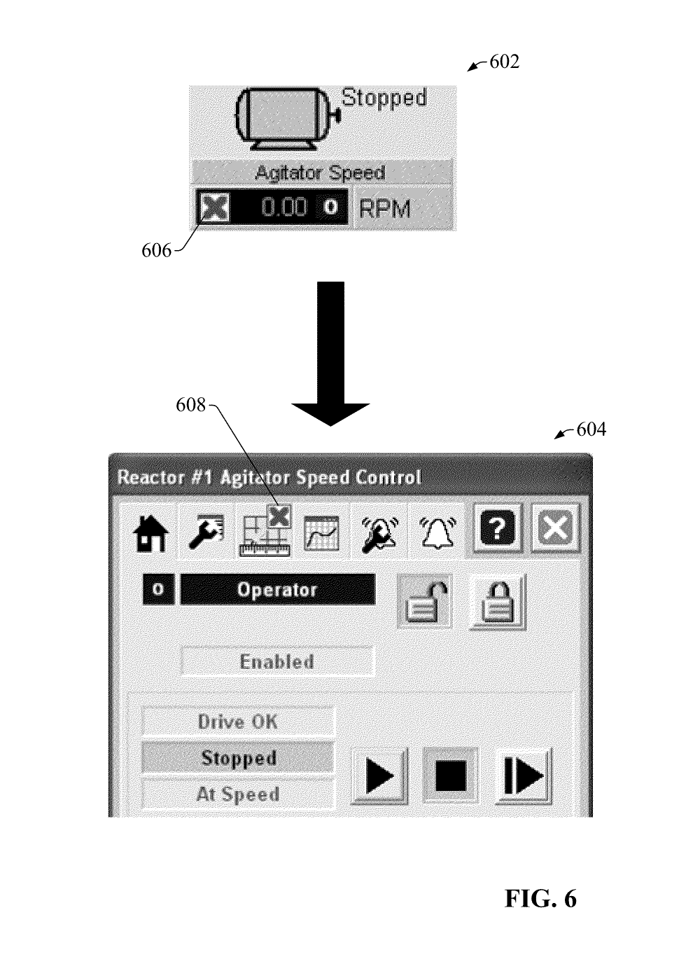

For example, if the operator is currently viewing the agitator overview screen 502, an “Invalid Configuration” icon 510 will be displayed on or near the graphical object representing the agitator for which the invalid configuration is detected. If the operator chooses to investigate the advisable state event, selection of the “Invalid Configuration” icon 510 will navigate to the agitator speed control screen 504. This navigational step is illustrated by the exemplary display screen segments of FIG. 6. Agitator graphic object 602, representing Reactor #1 Agitator, resides on the agitator overview screen 502, and is one of multiple agitator graphics on that screen. This agitator graphic object 602 represents a high-level summary view of Reactor #1 graphic that displays the agitator's state and speed. In response to detection of the invalid configuration, the advisable state notification framework renders the “Invalid Configuration” icon 606 next to the speed value. Selecting this icon (e.g., using a cursor, interaction with a touch-screen, etc.) navigates to the agitator Speed Control screen 604 for the Reactor #1 Agitator (corresponding to the agitator speed control screen 504 of navigation map 500).

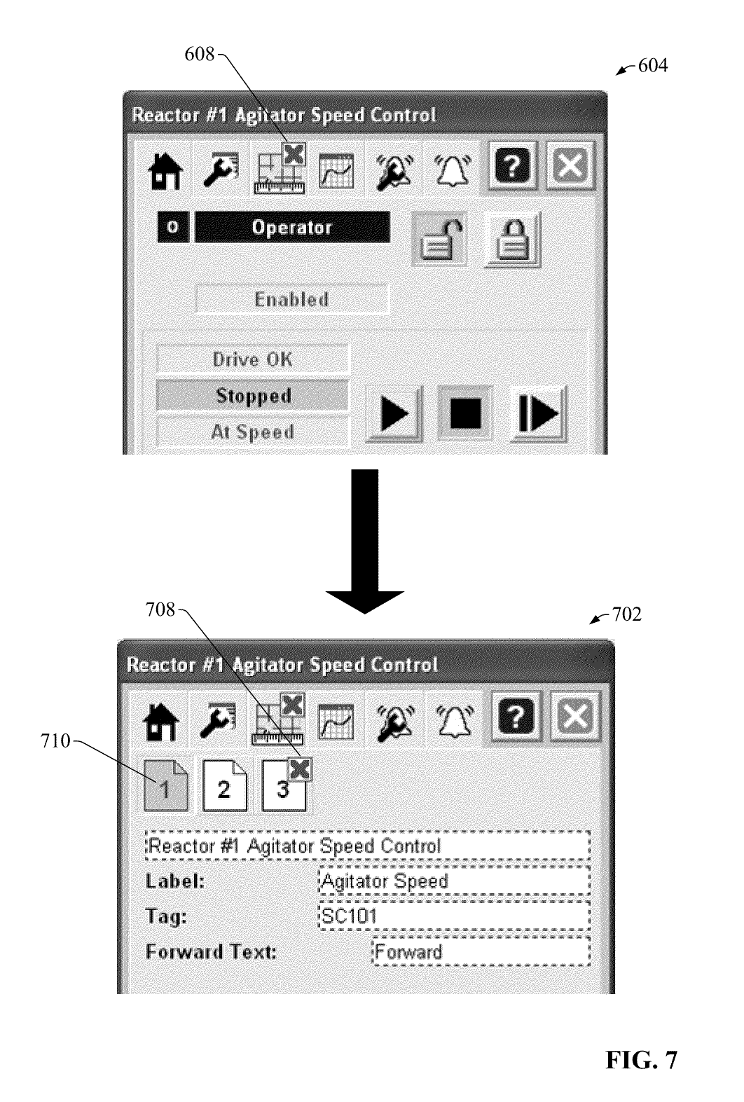

As shown in navigation map 500, from the agitator speed control screen 504, the operator can select one of four different sub-screens (Home, Tag Configuration, Graphing, or Alarming). Since the advisable state event relates to an invalid configuration, the advisable state framework displays the “Invalid Configuration” icon 514 on the link that invokes the Tag Configuration screen 506. This is represented in FIG. 6 by the “Invalid Configuration” icon 608 on the Tag Configuration tab of the Speed Control screen 604. To guide the operator, icon 608 is rendered on the selectable screen tab that navigates to the Tag Configuration screen. As shown in FIG. 7, selecting this tab switches the Agitator Speed Control screen from the Home view to the Tag Configuration view 702 (corresponding to the tag configuration screen 506 of the navigation map 500 on FIG. 5).

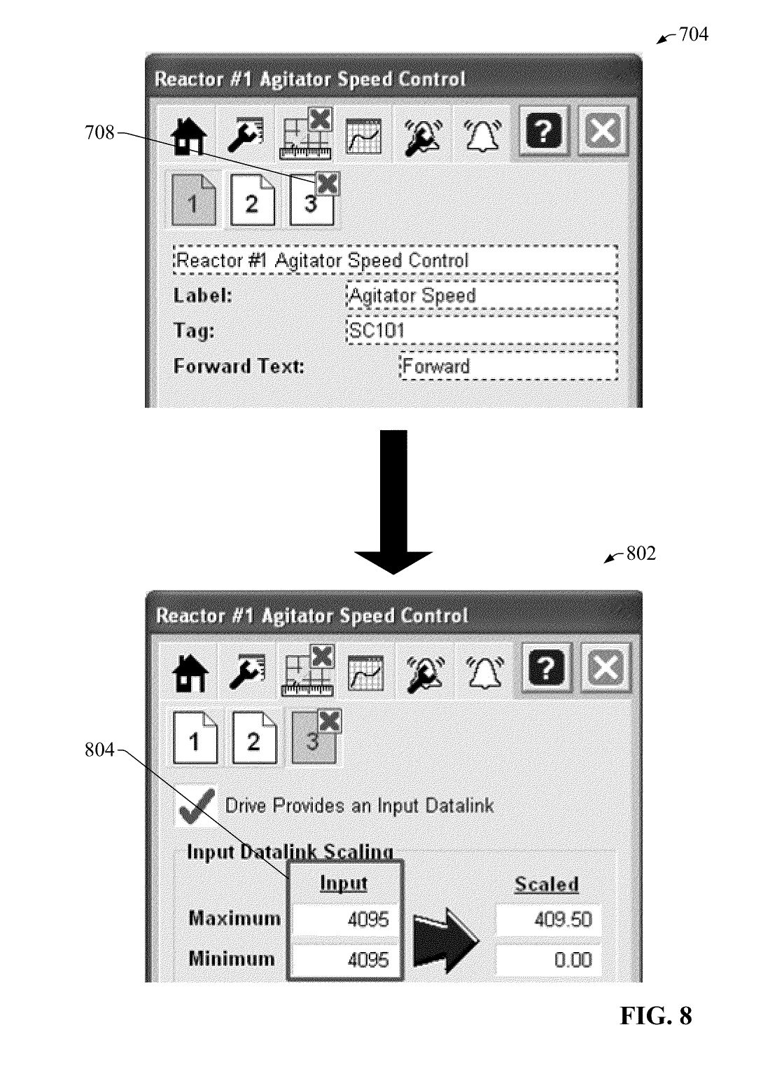

The Tag Configuration view 702 defaults to a Tag Mapping view (corresponding to sub-tab #1 710). However, the invalid scaling configuration parameters are located on the Scaling view accessible via sub-tab #3. Accordingly, the advisable state framework has rendered an “Invalid Configuration” icon 708 (corresponding to the icon 514 on navigation map 500) on this sub-tab to guide the user to the appropriate view. As shown in FIG. 8, selection of the sub-tab #3 navigates to the Input Datalink Scaling screen 802 for Reactor #1 Agitator (corresponding to the Tag Configuration Scaling screen 508 of navigation map 500), where the misconfigured scaling parameters are located. On this screen, the advisable state framework has highlighted the invalid configuration parameters 804 in a magenta box (colored for consistency with the “Invalid Configuration” icons). In this example, the invalid configuration event is due to the same value being entered for both the maximum and minimum raw value input fields.

As discussed above in connection with FIG. 3, the advisable state framework can determine where advisable state notification icons should be rendered based in part on organizational model 324, which defines hierarchical relationships between units of an industrial enterprise. Thus, when the configuration error of the foregoing example is detected and rendered as an advisable state icon on scaling screen 508, the framework causes the advisable state to be inherited upward through the tag configuration screen 506 (icon 514), agitator speed control screen 504 (icon 512) and the agitator overview screen 502 (icon 510). There may be additional hierarchical levels above the agitator overview screen 502 that are not shown on navigation map 500 which will also inherit the advisable state for the scaling error (e.g., a plant overview screen).

As illustrated in the foregoing example, the advisable state framework supported by the operator interface documents the advisable state event at appropriate locations throughout the screen navigation hierarchy using class-specific notification icons. This provides the operator with immediate information regarding the nature of the advisable state (by virtue of the class-specific advisable state icon) as well as a graphical mechanism to guide the user to information regarding the root cause of the advisable state event. It is to be appreciated that the advisable state framework and associated library of graphical objects allow these features to be incorporated into an operator interface application with minimal custom development required by the end user. For example, vendor-provided graphical objects available in the graphical object library (e.g., the agitator graphic object 602, the associated Speed Control screens 604, 702, and 802, etc.) can be pre-configured in accordance with the advisable state framework such that the objects render the appropriate class-specific icons when advisable state events are detected.

As noted above, the advisable state framework supports multiple classes of advisable state events. In addition to the “Invalid Configuration” class described in the previous example, other exemplary advisable state classes can include, but are not limited to, “Maintenance Bypass,” “I/O Fault,” “Operational Status,” “Confirmation Request,” or other such classifications.

“Maintenance Bypass” events are triggered when a maintenance bypass has been activated for a machine or device. A maintenance bypass can be activated, for example, when maintenance personnel have bypassed an interlock or a permissive for the machine or device. These advisable states convey to the operator that the machine is being run despite the lack of confirming run feedback. In a similar manner to the “Invalid Configuration” events described above, the advisable state framework renders “Maintenance Bypass” icons at appropriate locations of appropriate screens to guide the operator to additional information about the Maintenance Bypass event (e.g., identification of the machine that has been placed in bypass mode, an expected downtime duration, etc.).

“I/O Fault” events may be triggered when the data corresponding to an I/O value has not updated for an excessive duration of time, which suggests a fault with the I/O point. I/O Fault indications alert the operator that the data value associated with the flagged I/O point may be out of date or “stale.” “I/O Fault” icons can be used to guide the operator to the affected device and I/O point.

“Operational Status” events may be general statuses indicative of a device's operational readiness. In some embodiments, an “Operational Status” advisable state icon may be displayed on a device graphic when that device is not ready to operate. “Operational Status” icons can be used to guide the operator to the affected device and other information relating to the cause of the machine status.

“Confirmation Request” events may be triggered, for example, when a particular step of an automated process or sequence requires manual confirmation from the operator before the process is allowed to proceed. “Confirmation Request” advisable states may also be triggered when an event is detected that is not necessarily critical to continued operation of the process, but which may be of interest to the operator (e.g., an ingredient hopper has dropped below a defined level, and the operator may wish to fill the hopper to prevent exhausting the supply of the ingredient at a future time). For example, “Confirmation Request” icons may be used to guide the operator to the screen containing the process value determined to be of possible interest to the operator (e.g., the fill percentage of the ingredient hopper). The screen may also display a message providing additional information about the confirmation request (e.g., “Verify that the ingredient hopper is full”) and asking the operator to confirm that the value has been checked. Confirmation input from the user via the operator interface will then clear the “Confirmation Request” event, removing the icons from the screens.

It is to be appreciated that the classes of advisable states described above are only intended to be exemplary, and that any suitable classification definitions are within the scope of this disclosure. In one or more embodiments, the advisable state framework can support both pre-defined, vendor-provided classes of advisable states, as well as user-defined classes. Each class supported by the framework is distinguished by a class-specific icon that quickly conveys to the operator the nature of the advisable state.

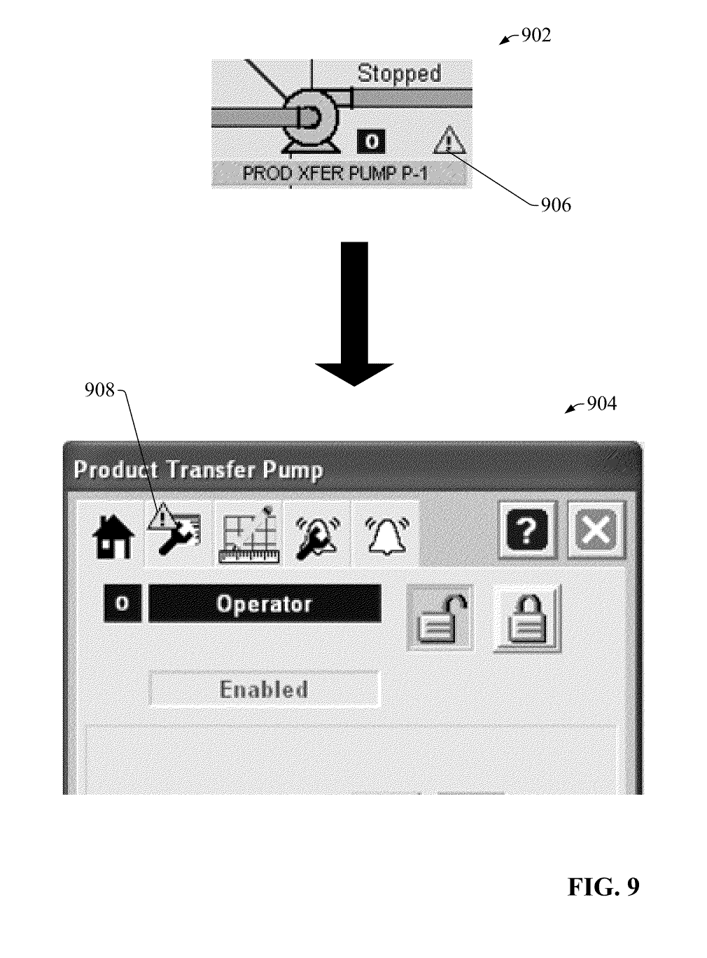

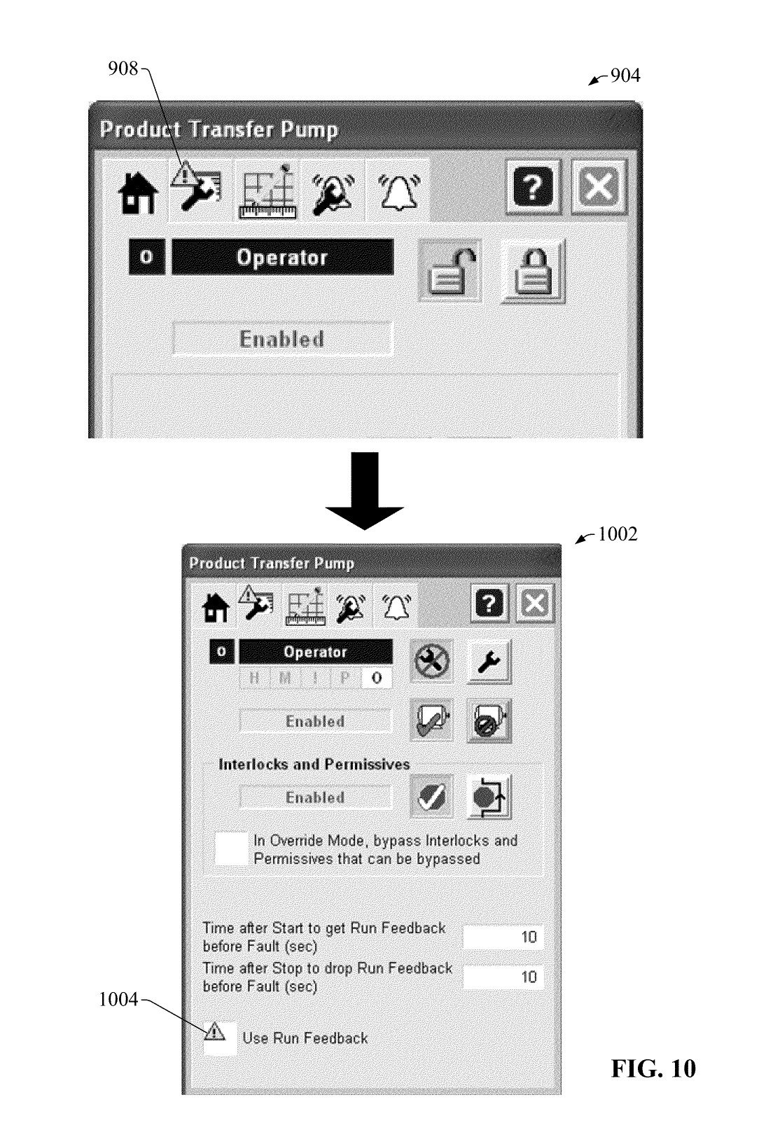

FIGS. 9 and 10 illustrate another exemplary advisable state event. In this example, a transfer pump has been placed in maintenance bypass by service personnel. In response to detection of this event (either by the advisable state framework of the operator interface or by the industrial controller in response to detection of a state change of a maintenance bypass variable associated with the pump's controller tag), the “Maintenance Bypass” icon is displayed on appropriate displays throughout the navigational hierarchy of the operator interface application. At the highest level, as illustrated in FIG. 9, a “Maintenance Bypass” icon 906 is displayed near a graphical object 902 representing the affected pump on an overview screen. The “Maintenance Bypass” class of advisable states is represented by a yellow triangle marked with an exclamation point. Selecting this icon navigates to the Home screen 904 for the affected pump. Since the maintenance bypass mode is set on the Maintenance screen for the pump, a Maintenance Bypass icon 908 is rendered on the Maintenance tab. As illustrated in FIG. 10, selecting the Maintenance tab navigates to the Maintenance screen 1002, where the maintenance bypass mode for the affected pump is shown. In the present example, the maintenance bypass was triggered by the fact that run feedback 1004 is not being used for the motor even though the motor is configured to have run feedback.

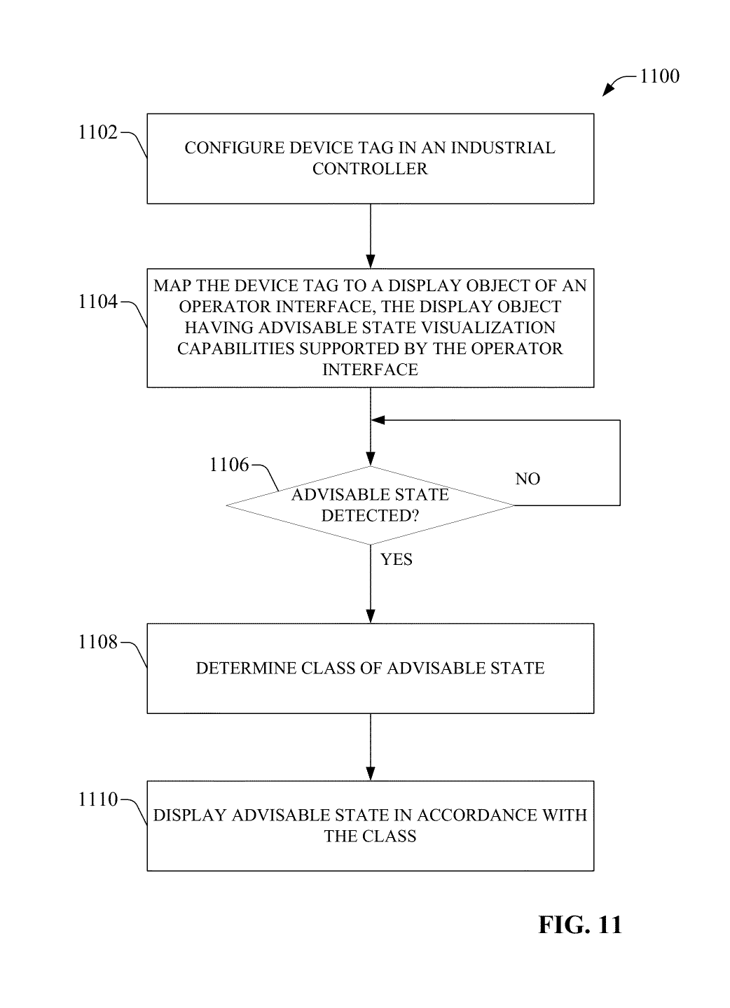

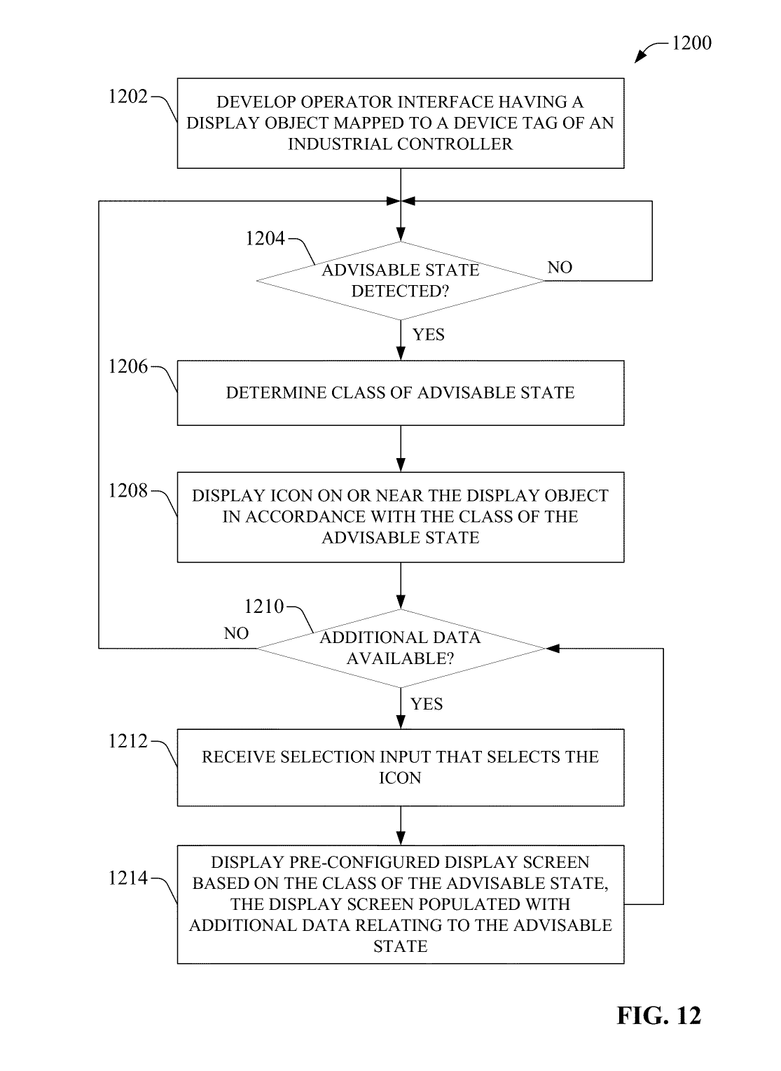

FIGS. 11-12 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 11 illustrates an example methodology 1100 for providing advisable state notifications to an operator on an operator interface. Initially, at 1102, a device tag is configured in an industrial controller. In one or more embodiments, the controller can support advisable state reporting via the device tag, which can be leveraged by an advisable state framework in an operator interface system to facilitate advisable state notifications.

At 1104, the device tag is mapped to a display object of an operator interface. By virtue of the operator interface's advisable state notification framework, the display object can include preconfigured advisable state visualization capabilities as described in previous examples. These capabilities can include class-specific event notification and guided navigation. At 1106, a determination is made as to whether an advisable state has been detected. If no advisable state is detected at 1106, the methodology continues to monitor for occurrence of an advisable state event. Alternatively, if an advisable state is detected at 1106, the class of the advisable state is determined. Exemplary states can include, but are not limited to, “Maintenance Bypass,” “Configuration Error,” “I/O Fault,” “Operational Status,” “Confirmation Request,” or other such classifications. At 1110, the advisable state is displayed in accordance with the class determined at 1108. This can include, for example, displaying a class-specific icon at selected locations throughout the operator interface navigation hierarchy.

FIG. 12 illustrates an example methodology 1200 for class-specific guided navigation in response to an advisable state event. Initially, at 1202, an operator interface is developed that includes a display object mapped to a device tag of an industrial controller. At 1204, a determination is made regarding whether an advisable state for a device or machine represented by the display object has been detected. This determination can be based on a value provided by the device tag in the industrial controller, or by values internal to the operator interface (e.g., manual settings entered via input fields of the operator interface). If no advisable state is detected at 1204, the methodology continues to monitor for advisable state events. Alternatively, if an advisable state event is detected at 1204, a class of the advisable state is determined at 1206.

At 1208, an icon is displayed on or near the display object in accordance with the class of the advisable state detected at 1204. The icon can comprise a unique graphic representing the class of the advisable state detected at 1204. At 1210, a determination is made regarding whether additional data relating to the detected advisable state is available. The additional data can comprise, for example, data located on other screens of the operator interface (e.g., screens that are accessible from a current screen). If no additional data for the advisable state is available, the methodology returns to 1204 to continue monitoring for advisable states.

Alternatively, if additional data is available, selection input is received at 1212 that selects the icon displayed at 1208. In response, at 1214, a pre-configured display screen or window is displayed based on the class of the advisable state, and the display screen is populated with additional data relating to the advisable state.

Embodiments, systems, and components described herein, as well as industrial control systems and industrial automation environments in which various aspects set forth in the subject specification can be carried out, can include computer or network components such as servers, clients, programmable logic controllers (PLCs), automation controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as I/O modules including analog, digital, programmed/intelligent I/O modules, other programmable controllers, communications modules, sensors, actuators, output devices, and the like.

The network can include public networks such as the Internet, intranets, and automation networks such as control and information protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, Local Area Networks (LANs), Wide Area Networks (WANs), proxies, gateways, routers, firewalls, virtual private network (VPN) devices, servers, clients, computers, configuration tools, monitoring tools, and/or other devices.

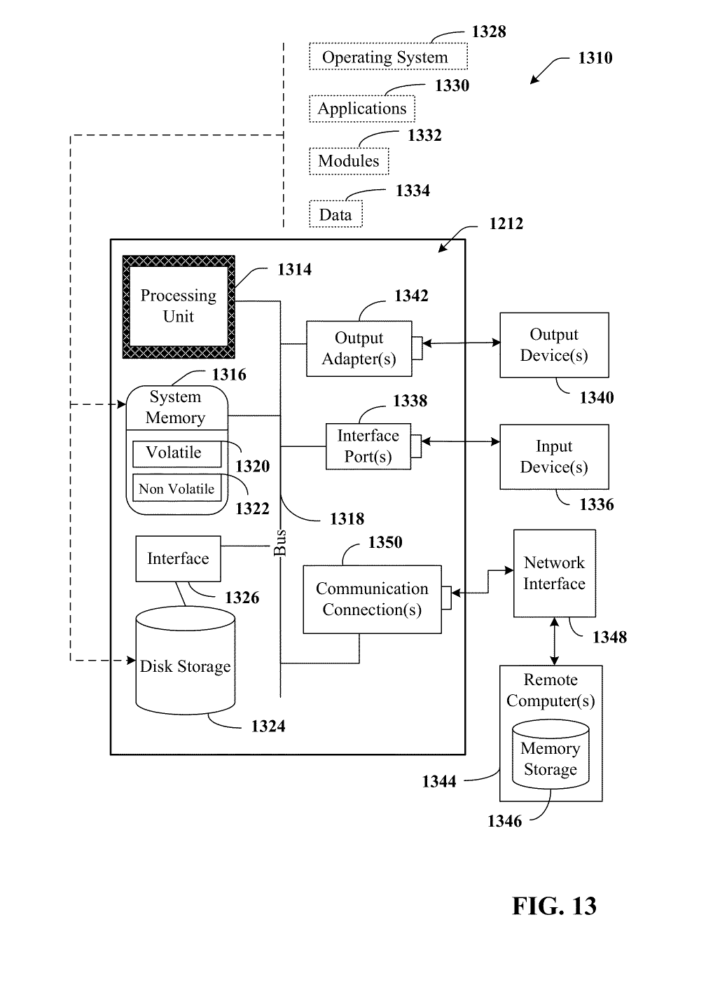

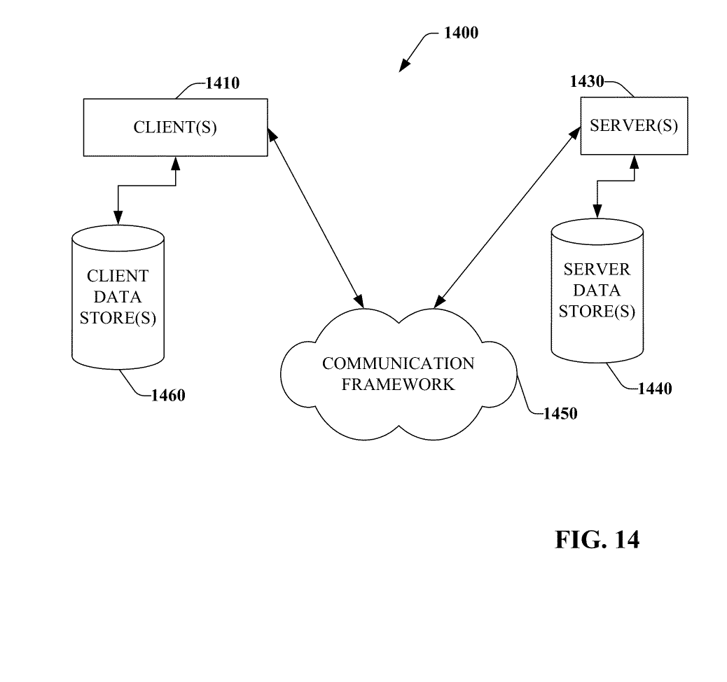

In order to provide a context for the various aspects of the disclosed subject matter, FIGS. 13 and 14 as well as the following discussion are intended to provide a brief, general description of a suitable environment in which the various aspects of the disclosed subject matter may be implemented.

With reference to FIG. 13, an example environment 1310 for implementing various aspects of the aforementioned subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Multi-core microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable PROM (EEPROM), or flash memory. Volatile memory 1320 includes random access memory (RAM), which acts as external cache memory. By way of illustration and not limitation, RAM is available in many forms such as synchronous RAM, static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/nonvolatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer 1312. System applications 1330 take advantage of the management of resources by operating system 1328 through program modules 1332 and program data 1334 stored either in system memory 1316 or on disk storage 1324. It is to be appreciated that one or more embodiments of the subject disclosure can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the system bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample computing environment 1400 with which the disclosed subject matter can interact. The sample computing environment 1400 includes one or more client(s) 1410. The client(s) 1410 can be hardware and/or software (e.g., threads, processes, computing devices). The sample computing environment 1400 also includes one or more server(s) 1430. The server(s) 1430 can also be hardware and/or software (e.g., threads, processes, computing devices). The servers 1430 can house threads to perform transformations by employing one or more embodiments as described herein, for example. One possible communication between a client 1410 and a server 1430 can be in the form of a data packet adapted to be transmitted between two or more computer processes. The sample computing environment 1400 includes a communication framework 1450 that can be employed to facilitate communications between the client(s) 1410 and the server(s) 1430. The client(s) 1410 are operably connected to one or more client data store(s) 1460 that can be employed to store information local to the client(s) 1410. Similarly, the server(s) 1430 are operably connected to one or more server data store(s) 1440 that can be employed to store information local to the servers 1430.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

1. A system for notifying of advisable states in an industrial automation system, comprising:
a library of graphical display objects for an operator interface;
an event detection component configured to detect an occurrence of an advisable state event in an industrial automation system and determine an advisable state class, of a plurality of advisable state classes, to which the advisable state belongs; and
a notification component configured to render a first advisable state icon in association with one or more of the graphical display objects based on the advisable state class.

2. The system of claim 1, wherein the plurality of advisable state classes include at least one of an Invalid Configuration class, a Maintenance Bypass class, an I/O Fault class, an Operational Status class, or a Confirmation Request class.

3. The system of claim 1, wherein the plurality of advisable state classes are associated with respective unique advisable state icons.

4. The system of claim 1, wherein the notification component is further configured to select a graphic for the first advisable state icon based on the advisable state class.

5. The system of claim 1, wherein the event detection component is further configured to detect the occurrence of the advisable state event based at least in part on data received from a device tag of an industrial controller.

6. The system of claim 1, wherein selection of the first advisable state icon causes the operator interface to navigate from a first display screen containing the first advisable state icon to a second display screen containing additional information regarding the advisable state event.

7. The system of claim 1, wherein the notification component is further configured to identify a navigation path from a first display screen containing the first advisable state icon to a second display screen that contains information relating to a cause of the advisable state event, and to display at least a second advisable state icon on one or more navigation links that lead to the second display screen.

8. The system of claim 1, further comprising a configuration component configured to receive configuration input that creates, as one of the plurality of advisable state classes, a custom advisable state class.

9. The system of claim 1, wherein the notification component is further configured to display a highlight on or around a value, displayed on an operator interface screen, that represents a source of the advisable state event.

10. The system of claim 9, wherein the highlight has a color that matches a color of the first advisable state icon.

11. The system of claim 1, wherein at least one of the one or more graphical display objects is a graphical object representing a device that triggered the occurrence of the advisable state event.

12. A method for notifying of advisable state events via an operator interface, comprising:
detecting an occurrence of an advisable state event in an industrial automation system;
determining, by an operator interface system, a classification of the advisable state; and
displaying, in response to the detecting, a first advisable state icon on a graphical object of the operator interface system, wherein the first advisable state icon is selected based on the classification.

13. The method of claim 12, wherein the determining comprises determining that the advisable state event is one of an Invalid Configuration event, a Maintenance Bypass event, an I/O Fault event, an Operational Status event, or an Confirmation Request event.

14. The method of claim 12, wherein the detecting comprises detecting the occurrence of the advisable state event based at least in part on data received from a device tag of an industrial controller.

15. The method of claim 12, further comprising:
in response to receiving input selecting the first advisable state icon, navigating from a current display screen of the operator interface to a second display screen that contains information relating to the advisable state event.

16. The method of claim 12, further comprising:
in response to the detecting an occurrence of an advisable state event:
determining a screen navigation path from a first display screen that contains the graphical object to a second display screen that contains information regarding a cause of the advisable state event; and
displaying one or more second advisable state icons on respective one or more navigation links that navigate to the second display screen.

17. The method of claim 12, further comprising receiving configuration input that creates a new classification of advisable state events.

18. A computer-readable medium having stored thereon computer-executable instructions that, in response to execution, cause a computing system to perform operations, the operations including:
determining that a state of a device of an industrial automation system corresponds to an advisable state defined in an operator interface system;
in response to the determining:
determining an advisable state class, of a plurality of advisable state classes, corresponding to the advisable state; and
rendering, on a first display screen of the operator interface system, a first advisable state icon in association with a graphical display object representing the device, wherein the first advisable state icon is selected based on the class of the advisable state.

19. The computer-readable medium of claim 18, the operations further comprising:
receiving, via the operator interface system, input that selects the first advisable state icon; and
in response to the receiving the input, navigating to a second display screen that contains information regarding the state.

20. The computer-readable medium of claim 18, the operations further comprising rendering a second advisable state icon on a navigation link configured to navigate from the first display screen to a second display screen that contains information regarding the state.
